(19) United States
(12) Patent Application Publication
(10) Pub. No.: US 2010/0037510 A1
(43) Pub. Date: Feb. 18, 2010

(54) FLOAT DEVICE

(76) Inventor: Dan NAHOOM, Haifa (IL)

Correspondence Address: William H. Dippert;Eckert Seamans Cherin & Mellott, LLC, U.S. Steel Tower, 600 Grant Street, 44th Floor, Pittsburgh, PA, 15219, US

(21) Appl. No.: 12/533,366

(22) Filed: Jul. 31, 2009

Related U.S. Application Data
(60) Provisional application No. 61/089,724, filed on Aug. 18, 2008.

(51) Int. Cl. A01K 91/00

(52) U.S. Cl. 43/43.14

(57) ABSTRACT

The present invention describes floating devices with adjustable floating and buoyancy capabilities. Such a float can facilitate as an improved fishing float device whose weight can be changed based on fishing conditions and fishing locations. Another use for the invention can be on floating ropes dividing swimming lanes.

### CROSS-REFERENCE TO RELATED APPLICATION

The present invention claims priority of Provisional Patent Application Ser. No. 61/089,724, filed Aug. 18, 2008, the contents of which are incorporated herein.

### FIELD OF THE INVENTION

The present invention relates to floats. More particularly, the present invention relates to an improved fishing float that has adjustable floating and buoyancy capabilities.

### BACKGROUND OF THE INVENTION

A standard fishing system comprises as a minimum a fishing line, fishing float, weights and a hook. In order to determine the size of the weight to be used, several variables are considered. One variable is the weight of the bait—the greater the weight of the bait is, the greater the total weight of the fishing system is. Another variable is the distance that the fisherman wants to cast his line to. The further the cast distance is, the heavier the weight should be. Another variable is the wind conditions on the fishing site. The stronger the wind is, the heavier the weight should be.

The fishing float used in the fishing system should float and support its own weight, as well as the weight of the weights, the hook and the bait. Since some of the components are made of heavy materials, the float should have a considerable high volume. Due to the volume of the float and the weight of the whole system, it behaves very differently from the natural fish food that it is supposed to resemble.

Current solutions which are available for providing a float which facilitates and promotes long distance casting, include the system described in U.S. Pat. No. 3,757,453 titled “Fishing Line Float” by Therres. The float comprises a hollow, normally sealed shell, of raindrop or cigar-shaped design. It is loaded with a predetermined quantity of water, insufficient to fill the shell but sufficient to fill a substantial portion of it. The float shell is designed to have the leader and line connected to its pointed end. The float shell is desirably composed of a transparent, deformable, typically elastic plastic material which does not shatter when the float is caused accidentally to hit a tree, boulder or other hard object. The floating level of the shell can be adjusted by squeezing the shell to expel air and releasing the shell underwater whereupon water is drawn into the shell. However, in order to keep the water at the desired level within the shell, U.S. Pat. No. 3,757,453 describes a mechanism for closing the hole once a predetermined quantity of water has been drawn into the float shell. This device comprises of at least two parts (the body and the cover for plugging the hole), as a result it often has leaking problems due to erosion that are caused over time. In addition, since the fishing line and leader trail extend from the same end of the float shell, the line and leader may become tangled.

There is a need for an improved float which is readily adjusted to different weights and buoyancies and is robust to sustain hard conditions. The present invention addresses this need.

### SUMMARY OF THE INVENTION

In accordance with a first embodiment, the present invention is directed to providing fishing float device with changing floating and bouncing capabilities as desired. The float device comprises a flexible wall containing a cavity and at least one aperture provided through said flexible wall such that under atmospheric pressure, liquid contained within said cavity does not escape.

Preferably, the aperture comprises a capillary-hole having dimensions such that fluid communication between said cavity and surrounding environment is possible only by applying pressure to the flexible wall.

Optionally, the aperture comprises a valve-hole having dimensions such that, under normal conditions, said valve-hole remains closed and, fluid within said cavity remains within the cavity.

Preferably, the flexible wall comprises a single piece of material.

Optionally, at least one protrusion extends from an exterior surface of said flexible wall for securing to a line. Optionally, two protrusions extend from an exterior surface of said flexible wall for securing two lines.

In various embodiments the cavity of the float device has a shape selected from a group consisting of: a generally toroidal shape, a disk shape, a cigar shape and antenna shape.

In various embodiments the cavity of the float device has a generally toroidal shape and comprises a central channel.

In other various embodiments the cavity of the float device has a generally disk shape or antenna shape and comprises a central channel.

Optionally, a fastener is provided for coupling a cord passing through said central channel to said float. Optionally, the fastener is a coupling or wedged pin. Optionally the fastener comprising two clips, one on each side of said central channel, for fastening said cord to said float.

In other various embodiments the float device is directed to act as a liquid weight when fully filled.

In accordance with another embodiment the invention is directed to providing a fishing line comprising the float.

In accordance with another embodiment the invention is directed to providing floating ropes for dividing swimming lanes.

### DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 illustrates an improved float in accordance with one embodiment of the present invention, and

FIG. 2 illustrates an improved float in accordance with another embodiment of the present invention.

### DETAILED DESCRIPTION OF THE INVENTION

Before explaining at least one embodiment of the invention in detail, it is to be understood that the invention is not necessarily limited in its application to the details set forth in the following description or exemplified by the examples. The invention is capable of other embodiments or of being practiced or carried out in various ways.

It will be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

The present invention provides a unique and novel improved float adapted especially for better weight adjustment and buoyancy capabilities.

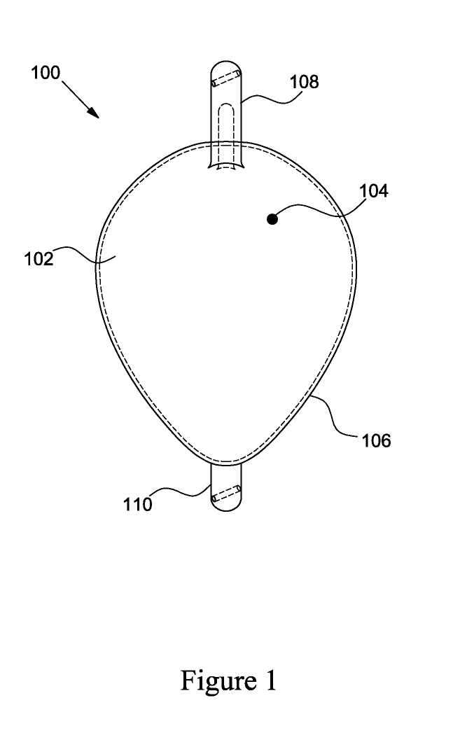

Reference is now made to FIG. 1 illustrating an improved float in accordance with a preferred embodiment of the present invention. The float 100 is a hollow float, of any size and shape, made as one piece comprising a wall 106 and a cavity 102. It is a particular feature of the current invention that at least one aperture 104 is provided through the wall 106.

According to various embodiments of the invention, the aperture 104 may be a capillary or other small hole having dimensions selected such that fluid communication between the cavity and the environment is provided when pressure difference is applied through applying force on the flexible wall. Alternatively, the aperture 104 maybe a valve-hole (a miniature hole acting as a valve) which is normally closed but may be opened upon pressure difference between the cavity and the surrounding of wall 106.

When open, the aperture 104 allows fluid communication between cavity 102 and the outer environment. Optionally a plurality of such miniature holes may be provided. The weight and buoyancy characteristics of the float 100 may be adjusted by filling the cavity 102 with fluid, typically water or other liquid in which it floats.

The valve-hole in the embodiment of the present invention does not feature any sealing component.

Since the float 100 is made of flexible material, for example: rubber, elastic polymer etc., the float wall 106 can be pressed and released so as to achieve a pumping effect. Pressing the wall 106 causes air contained within the cavity 102 to be expelled. In order for cavity 102 to be filled, the float 100 may be at least partly submerged in liquid such that the holes 104 are positioned within the liquid and then the wall 106 are released. The material of the wall 106 is selected such that upon release the cavity 102 returns to its original shape drawing liquid through the holes 104.

The pumping effect provides the float 100 with adjustability such that the buoyancy and the weight may be adjusted to achieve the goal of stabilizing the float 100 and allowing the casting weight to suit conditions. It is further noted that the characteristics may also be altered to better imitate the behavior of the natural food.

When there is a need to decrease the casting weight or to increase the buoyancy, the float 100 may be removed from the liquid and liquid trapped inside the cavity 102 may be expelled. Typically, the float 100 may be positioned so that holes 104 are open to the surrounding air and liquid trapped inside the cavity 102 is covering the apertures 104. When the float walls 106 are pressed fluid is pushed out of the float cavity 102. When the walls 106 are released air may be drawn into cavity 102 via the apertures 104.

In embodiments in which the float 100 comprises more then one hole 104, it may be desirable that only a single hole is used for this purpose, the remaining holes being temporarily sealed during this operation. Holes 104 may be sealed using the fingers of the person operating float 100, for example.

It is noted that the device described in U.S. Pat. No. 3,757,453 uses a shell like float with comparative large hole and describes a mechanism for closing the hole with a screw once a predetermined quantity of water was sucked into the shell. Specifically, their hole and mechanism for closing it are located in the bottom of the shell and the closing mechanism comprises a screw; in addition, the outer part of the screw has a ring for connecting the shell to the fishing line; as a result there is a chance for tangling the fishing line and the leader that is connected to yet another ring extended from the outer part of the screw.

In contradistinction to the prior art, the float 100 of embodiments of the current invention is preferably made of one piece, to provide extra robustness, of a flexible material, preferably transparent plastic, nylon, rubber or polyethylene. The size of the hole 104 is miniature or capillary as mentioned hereinabove such that liquid may not escape from cavity 102 under atmospheric pressure. Due to the size of holes 104, the liquid will not leak out from float 100 during floatation.

The float 100 can be connected to a fishing line using several techniques.

According to some embodiments, a first protrusion 108 is provided to float 100 so as to connect the float to a line connected to the fishing rod and a second protrusion 110 is provided so as to connect the float to the line that is connected to the hook.

Although FIG. 1 illustrates a hole 104 in the upper portion of float 100, in other embodiments of the present invention, other positioning of the holes may be preferred.

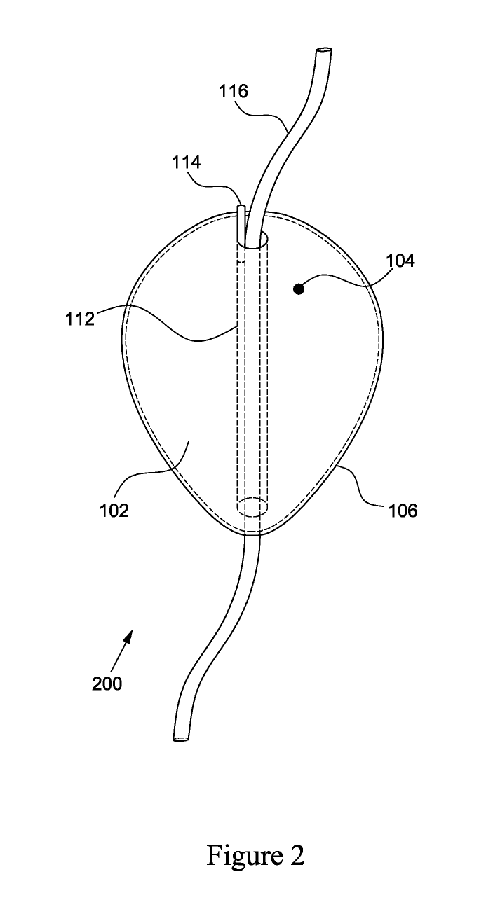

Reference is now made to FIG. 2 illustrating an improved float 200 in accordance with another embodiment of the present invention. The cavity 102 has a generally toroidal shape, a disk shape, a donut ring shape, a cigar shape, an antenna shape or any other shape with a crossing channel 112. The toroidal shape is generated by a cavity having a generally D-shaped or tear-drop profile being rotated about a central axis.

A line, rope, or any cord 116 may pass through the channel 112. Optionally, the line 116 is a fishing line that is connected at one end to the fishing-rod (not shown) and which passes through the channel 112. In order to lock float 200 at the desired location on the line a wedge-pin may be urged 114 into the crossing channel to hold the line in place. Alternatively, clips of other such fastening means may be used for securing float 200 in the proper location on the line.

Although the embodiments of the invention for use on fishing lines are described above, in other embodiments, multiple floats 200 may be threaded along a single line to float the line along the liquid surface. The weight of the floats may secure the rope in its place floating on the liquid. The floating lines may be used to divide the whole liquid surface into separate areas. Such an arrangement may be used, for example, as dividers separating swimming lanes, for containing oil spills, for marking boundaries or the like.

It should be clear that the description of the embodiments and attached Figures set forth in this specification serves only for a better understanding of the invention, without limiting its scope as covered by the following Claims.

It should also be clear that a person skilled in the art, after reading the present specification can make adjustments or amendments to the attached figures and above described embodiments that would still be covered by the following claims.

What is claimed:

1 An improved float comprising:
a flexible wall containing a cavity; and
at least one aperture through said flexible wall.

2. The improved float as claimed in claim 1, wherein said aperture comprises a capillary-hole having dimensions such that fluid communication between said cavity and surrounding environment is provided when a pressure difference is maintained between said cavity and said surrounding environment.

3. The improved float as claimed in claim 2, wherein pressure difference is applied between said cavity and said surrounding environment by pressing the flexible wall.

4. The improved float as claimed in claim 1, wherein said aperture comprises a valve-hole having dimensions such that, under normal conditions, said valve-hole remains closed.

5. The improved float as claimed in claim 4, wherein the dimensions of said at least one valve-hole are selected such that, under normal conditions, fluid within said cavity remains within said cavity.

6. The improved float as claimed in claim 1, wherein said flexible wall comprises a single piece of material.

7. The improved float as claimed in claim 1, further comprising an attachment means for coupling said float to a line.

8. The improved float as claimed in claim 7, wherein said attachment means comprises at least one protrusion extending from an exterior surface of said flexible wall.

9. The improved float as claimed in claim 7, wherein said attachment means comprises at least two protrusions extending from an exterior surface of said flexible wall.

10. The improved float as claimed in claim 1, wherein the shape of said wall containing a cavity having a shape selected from a group consisting of: a generally toroidal shape, a disk shape, cigar shape and antenna shape.

11. The improved float as claimed in claim 10 wherein said toroidal shape comprises a D-shaped wall rotated about a central axis.

12. The improved float as claimed in claim 10 wherein said shape comprises a central channel.

13. The improved float as claimed in claim 12 further comprising a fastener for coupling a cord passing through said central channel to said float.

14. The improved float as claimed in claim 13 wherein said fastener comprises two clips, one on each side of said central channel, for fastening said cord to said float.

15. The improved float as claimed in claim 13 wherein said fastener comprises a coupling pin.

16. The improved float of claim 15 wherein said coupling pin comprises a wedge.

17. A fishing line comprising the float of claim 1.

18. Liquid surface dividers comprising buoyant cords supportable by at least one float of claim 1.

19. The improved float as claimed in claim 1, wherein being fully filled said improved float acts as a liquid weight.
